(19) United States
(12) Patent Application Publication
(10) Pub. No.: US 2024/0369253 A1
(43) Pub. Date: Nov. 7, 2024

(54) AIR CONDITIONER

(71) Applicant: FUJITSU GENERAL LIMITED, Kanagawa (JP)

(72) Inventors: Hiroaki TAKAHASHI, Kanagawa (JP); Junpei OKEDA, Kanagawa (JP); Kaoru KOKUTA, Kanagawa (JP)

(73) Assignee: FUJITSU GENERAL LIMITED, Kanagawa (JP)

(21) Appl. No.: 18/682,126

(22) PCT Filed: Jul. 25, 2022
(86) PCT No.: PCT/JP2022/028558

§ 371 Date: Feb. 8, 2024

(30) Foreign Application Priority Data
Oct. 15, 2021 (JP) 2021-169366

(51) Int. Cl. F24F 11/79; F24F 1/38; F24F 11/64; F24F 13/20

(52) U.S. Cl. CPC F24F 11/79; F24F 1/38; F24F 11/64; F24F 13/20

(57) ABSTRACT

An air conditioner according to an embodiment of the present invention includes: a refrigerant circuit including a compressor, an outdoor heat exchanger, an indoor heat exchanger, a pressure reducer that is disposed between the outdoor heat exchanger and the indoor heat exchanger, and a flow channel switching unit that switches a flow direction of a refrigerant discharged from the compressor; an outdoor fan that blows the air to the outdoor heat exchanger; and a control device that sets an instructed rotational frequency which is a rotational frequency for driving the outdoor fan. The control device performs processing of stopping the outdoor fan while gradually reducing the instructed rotational frequency in a case where it is determined that a predetermined defrosting start condition is satisfied during a heating operation.

### TECHNICAL FIELD

The present invention relates to an air conditioner having a defrosting driving mode.

### BACKGROUND ART

During a heating operation of an air conditioner, frost can be generated in an outdoor heat exchanger that functions as an evaporator if an outside air temperature is low. If a large amount of frost is generated in the outdoor heat exchanger, it prevents heat exchange between a refrigerant and outside air by the outdoor heat exchanger, which deteriorates the heat exchange capability in the outdoor heat exchanger. Therefore, during the heating operation of the air conditioner, a defrosting operation for melting frost generated in the outdoor heat exchanger is performed as appropriate.

The defrosting operation is performed when a preset defrosting start condition is satisfied. Typically, the defrosting operation is started when the temperature of the outdoor heat exchanger becomes equal to or lower than a temperature (defrosting start temperature) pre-set as a temperature at which frost adheres to the outdoor heat exchanger. The temperature of the outdoor heat exchanger at which defrosting is started is typically determined in accordance with the outside air temperature. The lower the outside air temperature is, the lower the defrosting start temperature is.

So-called reverse defrosting in which rotation of an outdoor fan is stopped, a refrigerant circuit is switched so that the outdoor heat exchanger changes from the state of functioning as the evaporator to the state of functioning as a condenser, a high-temperature refrigerant discharged from the compressor is made to flow in the outdoor heat exchanger, and frost generated in the outdoor heat exchanger is melted is known as a method of defrosting the outdoor heat exchanger (e.g., see Patent Literature 1). When a predetermined time has elapsed from the start of the reverse defrosting operation, considering that frost generated in the outdoor heat exchanger has all melted, the defrosting operation is terminated and the heating operation is restarted.

### CITATION LIST

### Patent Literature

Patent Literature 1: Japanese Patent Application Laid-open No. HEI 5-322264

Patent Literature 2: Japanese Patent Application Laid-open No. 2002-340367

### DISCLOSURE OF INVENTION

### Technical Problem

During the operation of the outdoor fan, operational noise such as wind noise is typically generated. With an air conditioner in which a heat source side unit is located outside the room and a use side unit is located inside the room, sandwiching an outer wall of a building, a user located in the room rarely notices a change in operational noise due to stop of the rotation of the outdoor fan which is a heat source side blower during the reverse defrosting.

However, in the case where the outdoor environment is more silent than that in the daytime for example during a midnight operation, the user located in the room sometimes notices a change in operational noise of the outdoor fan at the time of switching the reverse defrosting. Moreover, with an integrated-type air conditioner (e.g., see Patent Literature 2) in which a heat source side unit including a heat source side blower and a use side unit including a use side blower are disposed in a common casing, operational noise of the heat source side blower may more easily reach the user located in the room than operational noise of the use side blower. Therefore, depending on an operational environment of the air conditioner or a structure of the air conditioner, the user located in the room sometimes notices a change in operational noise of the heat source side blower, which is associated with switching of the reverse defrosting.

As described above, in the conventional air conditioner, when the rotation of the outdoor fan which is the heat source side blower is temporarily stopped, some users feel discomfort from a rapid change in operational noise of the outdoor fan. For those users, the usability of the air conditioner is impaired.

In view of the above-mentioned circumstances, it is an objective of the present invention to provide an air conditioner capable of preventing deterioration of the usability due to a change in operational noise of the outdoor fan.

### Solution to Problem

An air conditioner according to an embodiment of the present invention includes:

a refrigerant circuit including a compressor, an outdoor heat exchanger, an indoor heat exchanger, a pressure reducer that is disposed between the outdoor heat exchanger and the indoor heat exchanger, and a flow channel switching unit that switches a flow direction of a refrigerant discharged from the compressor;

an outdoor fan that blows the air to the outdoor heat exchanger; and

a control device that sets an instructed rotational frequency which is a rotational frequency for driving the outdoor fan.

The control device performs processing of stopping the outdoor fan while gradually reducing the instructed rotational frequency in a case where it is determined that a predetermined defrosting start condition is satisfied during a heating operation.

The air conditioner may further include an external casing fitted in an opening of a building wall that partitions an indoor space and an outdoor space, in which the outdoor heat exchanger and the outdoor fan are disposed in the external casing.

The control device may perform processing of stopping the outdoor fan in a predetermined period of from a time of stopping the compressor to a time of performing processing of switching a flow direction of the refrigerant from the indoor heat exchanger to the outdoor heat exchanger.

The processing of stopping the outdoor fan may include control to gradually reduce the instructed rotational frequency to a pre-set control rotational frequency and control to set the instructed rotational frequency to zero.

The processing of stopping the outdoor fan may reduce the instructed rotational frequency continuously, stepwisely, or at a constant rate.

### ADVANTAGEOUS EFFECTS OF INVENTION

In accordance with the present invention, it is possible to prevent deterioration of the usability due to a change in operational noise of the outdoor fan.

### BRIEF DESCRIPTION OF DRAWINGS

FIG. 1 A refrigerant circuit diagram of an air conditioner according to an embodiment of the present invention.

FIG. 2 A block diagram showing configurations of a control device in the air conditioner.

FIG. 3 A schematic view showing the air conditioner in which an outdoor unit as a heat source side unit is located outside the room and an indoor unit as a use side unit is located inside the room, sandwiching a building wall that partitions an indoor space and an outdoor space.

FIG. 4 A schematic view showing the air conditioner in which the outdoor unit as the heat source side unit is disposed in an external casing fitted in the opening penetrating the building wall that partitions the indoor space and the outdoor space.

FIG. 5 A flowchart showing an exemplary processing procedure of a reverse defrosting operation performed in the control device.

FIG. 6 A timing chart showing exemplary state changes of a compressor, a four-way valve, and an outdoor fan during the reverse defrosting operation.

### MODE(S) FOR CARRYING OUT THE INVENTION

Hereinafter, embodiments of the present invention will be described with reference to the drawings.

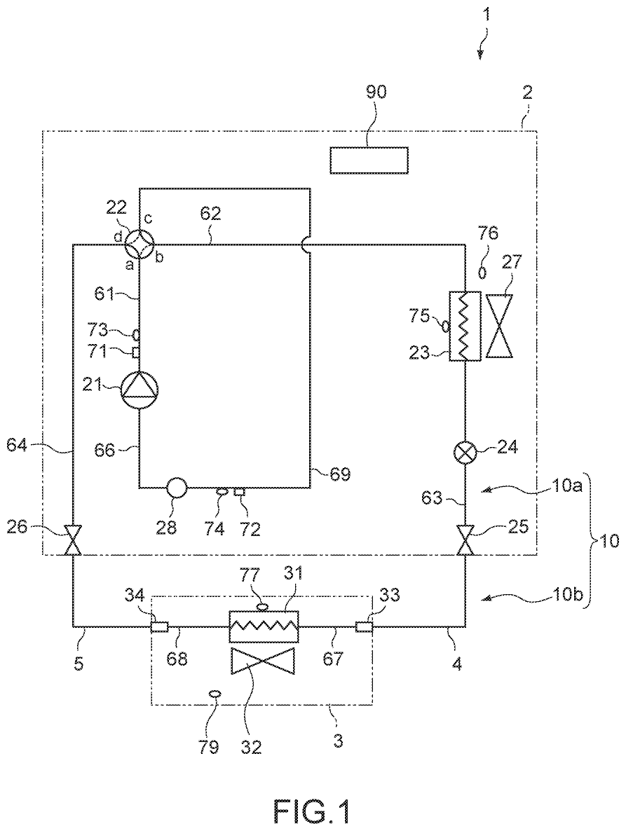

FIG. 1 is a refrigerant circuit diagram of an air conditioner according to an embodiment of the present invention. An air conditioner 1 according to the present embodiment includes an outdoor unit 2 and an indoor unit 3 connected to the outdoor unit 2 through a liquid pipe 4 and a gas pipe 5. Specifically, a stop valve 25 of the outdoor unit 2 and a liquid pipe connection portion 33 of the indoor unit 3 are connected to each other through the liquid pipe 4. Moreover, a stop valve 26 of the outdoor unit 2 and a gas pipe connection portion 34 of the indoor unit 3 are connected to each other through the gas pipe 5. In such a manner, a refrigerant circuit 10 of the air conditioner 1 is formed.

### Configuration of Outdoor Unit

The outdoor unit 2 includes a compressor 21, a four-way valve 22, an outdoor heat exchanger 23, an expansion valve 24 as a pressure reducer, the stop valve 25 to which one end of the liquid pipe 4 has been connected, the stop valve 26 to which one end of the gas pipe 5 has been connected, an outdoor fan 27, and an accumulator 28. These devices excluding the outdoor fan 27 are connected to each other through each refrigerant pipe to be described later, thereby forming an outdoor unit refrigerant circuit 10a that forms a part of the refrigerant circuit 10.

The compressor 21 is a variable displacement compressor that includes a variable-rotational frequency motor (not shown) and changes the operation capacity by an inverter (not shown) controlling the rotational frequency of the motor to vary. A refrigerant discharge port of the compressor 21 is connected to a port a of the four-way valve 22 through a discharge pipe 61. Moreover, a refrigerant suction port of the compressor 21 is connected to a refrigerant flow-out port of the accumulator 28 through a suction pipe 66.

The four-way valve 22 is a flow channel switching unit for switching a direction (polarity) in which a refrigerant flows in the refrigerant circuit 10. Specifically, the four-way valve 22 switches the refrigerant circuit 10 to either one of a cooling refrigerant circuit that circulates the refrigerant discharged from the compressor 21 in the order of the outdoor heat exchanger 23, the expansion valve 24, an indoor heat exchanger 31, and the accumulator 28 and a heating refrigerant circuit that circulates the refrigerant discharged from the compressor 21 in the order of the indoor heat exchanger 31, the expansion valve 24, the outdoor heat exchanger 23, and the accumulator 28.

The four-way valve 22 includes four ports a, b, c, and d. As described above, the port a is connected to the refrigerant discharge port of the compressor 21 through the discharge pipe 61. The port b is connected to one refrigerant outlet/inlet of the outdoor heat exchanger 23 through a refrigerant pipe 62. The port c is connected to a refrigerant flow-in port of the accumulator 28 through a refrigerant pipe 69. The port d is connected to the stop valve 26 through an outdoor unit gas pipe 64.

The outdoor heat exchanger 23 exchanges heat of the outside air taken in the outdoor unit 2 with the refrigerant by rotation of the outdoor fan 27. As described above, one refrigerant outlet/inlet of the outdoor heat exchanger 23 is connected to the port b of the four-way valve 22 through the refrigerant pipe 62 and the other refrigerant outlet/inlet is connected to an outdoor unit liquid pipe 63 through the stop valve 25. The outdoor heat exchanger 23 functions as a condenser during a cooling operation and functions as an evaporator during a heating operation by switching of the four-way valve 22 to be described later.

The expansion valve 24 is an electronic expansion valve driven by a pulse motor (not shown). The expansion valve 24 is provided in the outdoor unit liquid pipe 63. Specifically, the degree of opening of the expansion valve 24 is adjusted to a degree of opening between full close and full open in accordance with the number of pulses added to the pulse motor. The degree of opening of the expansion valve 24 is adjusted depending on heating capability required by the indoor unit 3 during the heating operation and is adjusted depending on cooling capability required by the indoor unit 3 during the cooling operation.

The outdoor fan 27 is made of a resin material. The outdoor fan 27 is disposed in vicinity of the outdoor heat exchanger 23. Rotated by a fan motor (not shown), the outdoor fan 27 takes outdoor air (outside air) into the outdoor unit 2 through an air inlet (not shown) of the outdoor unit 2 and discharges the outside air whose heat has been exchanged with the refrigerant in the outdoor heat exchanger 23 to the outside of the outdoor unit 2 through an air outlet (not shown) of the outdoor unit 2.

The accumulator 28 separates the refrigerant that has flowed in it into a gas refrigerant and a liquid refrigerant. Then, the compressor 21 sucks only the gas refrigerant through the suction pipe 66. The refrigerant flow-in port of the accumulator 28 and the port c of the four-way valve 22 are connected to each other through the refrigerant pipe 69. The refrigerant flow-out port of the accumulator 28 and the refrigerant suction port of the compressor 21 are connected to each other through the suction pipe 66.

In addition to the configurations described above, the outdoor unit 2 is provided with various sensors. In the present embodiment, as shown in FIG. 1, the discharge pipe 61 is provided with a discharge pressure sensor 71 that detects a discharge pressure which is a pressure of the refrigerant discharged from the compressor 21 and a discharge temperature sensor 73 that detects a discharge temperature which is a temperature of the refrigerant discharged from the compressor 21. The refrigerant pipe 69 is provided with a suction pressure sensor 72 that detects a suction pressure which is a pressure of the refrigerant at which it is sucked by the compressor 21 and a suction temperature sensor 74 that detects a suction temperature which is a temperature of the refrigerant sucked by the compressor 21.

The outdoor heat exchanger 23 is provided with an outdoor heat exchange temperature sensor 75 that detects an outdoor heat exchange temperature which is a temperature of the outdoor heat exchanger 23. An outside air temperature sensor 76 that detects a temperature of the outside air flowing in the casing (not shown) of the outdoor unit 2, i.e., an outside air temperature is provided near the air inlet (not shown) of the outdoor unit 2.

### Configuration of Indoor Unit

Next, the indoor unit 3 will be described with reference to FIG. 1. The indoor unit 3 includes the indoor heat exchanger 31, an indoor fan 32, the liquid pipe connection portion 33 to which the other end of the liquid pipe 4 has been connected, and a gas pipe connection portion 34 to which the other end of the gas pipe 5 has been connected. These devices excluding the indoor fan 32 are connected to each other through each refrigerant pipe to be described later in detail, thereby forming an indoor unit refrigerant circuit 10b that forms a part of the refrigerant circuit 10.

The indoor heat exchanger 31 exchanges heat of indoor air taken in the indoor unit 3 through an air inlet (not shown) of the indoor unit 3 with the refrigerant by rotation of the indoor fan 32. One refrigerant outlet/inlet of the indoor heat exchanger 31 is connected to the liquid pipe connection portion 33 through an indoor unit liquid pipe 67. The other refrigerant outlet/inlet of the indoor heat exchanger 31 is connected to the gas pipe connection portion 34 through an indoor unit gas pipe 68. The indoor heat exchanger 31 functions as an evaporator in the case where the indoor unit 3 performs the cooling operation and functions as a condenser in the case where the indoor unit 3 performs the heating operation. It should be noted that in the liquid pipe connection portion 33 and the gas pipe connection portion 34, the refrigerant pipes are connected by welding, flare nuts, etc.

The indoor fan 32 is made of a resin material. The indoor fan 32 is disposed in vicinity of the indoor heat exchanger 31. Rotated by a fan motor (not shown), the indoor fan 32 takes the indoor air into the indoor unit 3 through the air inlet (not shown) of the indoor unit 3 and blows out the indoor air whose heat has been exchanged with the refrigerant in the indoor heat exchanger 31 to the inside through an air outlet (not shown) of the indoor unit 3.

In addition to the configurations described above, the indoor unit 3 is provided with various sensors. In the present embodiment, as shown in FIG. 1, the indoor unit liquid pipe 67 is provided with an indoor heat exchange temperature sensor 77 that detects an indoor heat exchange temperature which is a temperature of the indoor heat exchanger 31. A room temperature sensor 79 that detects a temperature of the indoor air flowing in the indoor unit 3, i.e., a room temperature is provided near the air inlet (not shown) of the indoor unit 3.

### Control Device

The air conditioner 1 includes a control device 90. The control device 90 is, for example, an outdoor unit control device provided in the outdoor unit 2. The control device 90 is mounted on a control board stored in an electric box (not shown) of the outdoor unit 2.

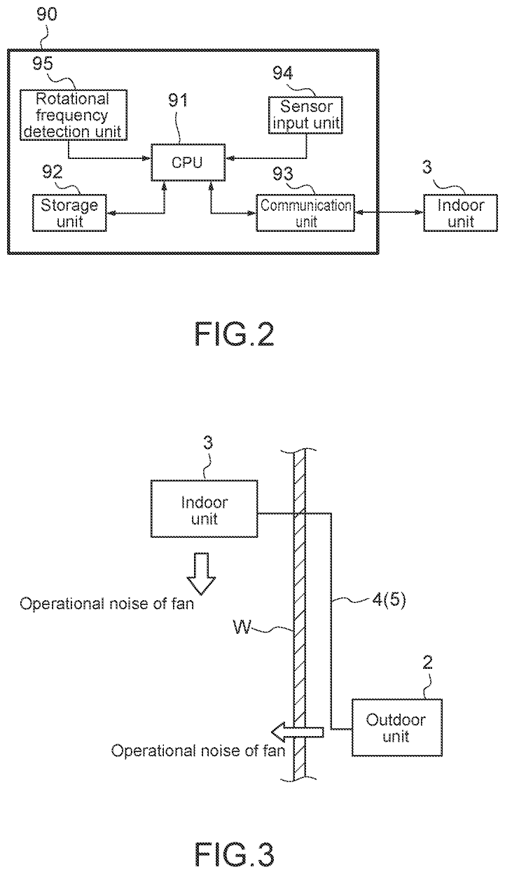

FIG. 2 is a block diagram showing configurations of the control device 90. As shown in the figure, the control device 90 includes a CPU 91, a storage unit 92, a communication unit 93, a sensor input unit 94, and a rotational frequency detection unit 95.

The storage unit 92 is a nonvolatile memory such as a flash memory. The storage unit 92 stores control programs and control parameters of the outdoor unit 2, control programs and control parameters corresponding to detected signals from the various sensors, control states of the compressor 21, the outdoor fan 27, and the like, a control state of the indoor unit 3 including the rotational frequency and the like of the indoor fan 32 acquired via the communication unit 93, and so on.

The communication unit 93 is an interface for communicating with the indoor unit 3. The sensor input unit 94 receives detection results from the various sensors of the outdoor unit 2 and outputs them to the CPU 91. The rotational frequency detection unit 95 detects rotational frequency of the motor of the compressor 21 and outputs it to the CPU 91. The rotational frequency detection unit 95 may be configured to directly detect the rotational frequency of the motor by an encoder or the like attached to a drive shaft of the motor or may be configured to detect the rotational frequency of the motor from a driving current supplied to the motor. In the following description, the rotational frequency of the compressor 21 refers to the rotational frequency of the motor.

The CPU 91 is a control unit that controls operations of the respective parts of the outdoor unit 2 including the compressor 21 by executing a program stored in the storage unit 92. The program is installed to the control device 90 via various types of recording media, for example. Alternatively, the program may be installed via the Internet, for example.

The CPU 91 receives detection results from the respective sensors of the outdoor unit 2 via the sensor input unit 94. In addition, the CPU 91 receives a control signal from the indoor unit 3 via the communication unit 93. Based on the received detection result and control signal, the CPU 91 controls driving of the compressor 21, the outdoor fan 27, and the indoor fan 32. For example, the CPU 91 sets an instructed rotational frequency which is a rotational frequency for driving them. Moreover, the CPU 91 controls switching of the four-way valve 22 on the basis of the received detection result and control signal. Furthermore, the CPU 91 adjusts the degree of opening of the expansion valve 24 on the basis of the received detection result and control signal.

### Operation of Refrigerant Circuit

Next, flows of the refrigerant and operations of the respective parts in the refrigerant circuit 10 during an air-conditioning operation of the air conditioner 1 in the present embodiment will be described with reference to FIG. 1.

### 1. Cooling Operation

In the case where the indoor unit 3 performs the cooling operation, the CPU 91 switches the four-way valve 22 to enter a state shown by the broken line as shown in FIG. 1. Specifically, the CPU 91 switches the four-way valve 22 so that the port a and the port b are in communication with each other and the port c and the port d are in communication with each other. Accordingly, a cooling cycle in which the outdoor heat exchanger 23 functions as a condenser and the indoor heat exchanger 31 functions as an evaporator is provided.

The refrigerant discharged from the compressor 21 flows through the discharge pipe 61 and flows in the four-way valve 22. Then, the refrigerant flows through the refrigerant pipe 62 from the four-way valve 22 and flows in the outdoor heat exchanger 23.

The refrigerant that has flowed in the outdoor heat exchanger 23 exchanges heat with the outside air taken in the outdoor unit 2 and is condensed by rotation of the outdoor fan 27.

The refrigerant that has flowed out from the outdoor heat exchanger 23 flows through the outdoor unit liquid pipe 63 and is reduced in pressure when passing through the expansion valve 24. The degree of opening of the expansion valve 24 during the cooling operation is adjusted so that the discharge temperature of the compressor 21 becomes a predetermined target temperature. The refrigerant that passed through the expansion valve 24 flows to the liquid pipe 4 via the stop valve 25. The refrigerant that has flowed through the liquid pipe 4 and flowed in the indoor unit 3 via the liquid pipe connection portion 33 flows through the indoor unit liquid pipe 67 and flows in the indoor heat exchanger 31.

The refrigerant that has flowed in the indoor heat exchanger 31 exchanges heat with the indoor air taken in the indoor unit 3 and is evaporated by rotation of the indoor fan 32. In this manner, the indoor heat exchanger 31 functions as an evaporator, and the indoor air cooled by heat exchange with the refrigerant in the indoor heat exchanger 31 is blown out to the room through the air outlet (not shown). As a result, the room where the indoor unit 3 is installed is cooled.

The refrigerant that has flowed out from the indoor heat exchanger 31 flows through the indoor unit gas pipe 68 and flows to the gas pipe 5 via the gas pipe connection portion 34. The refrigerant that has flowed through the gas pipe 5 flows in the outdoor unit 2 via the stop valve 26. Then, the refrigerant flows through the outdoor unit gas pipe 64, the four-way valve 22, the refrigerant pipe 69, the accumulator 28, and the suction pipe 66 in the stated order. Then, the refrigerant is sucked and re-compressed by the compressor 21.

### 2. Heating Operation

In the case where the indoor unit 3 performs the heating operation, the CPU 91 switches the four-way valve 22 to a state shown by the solid line as shown in FIG. 1. Specifically, the CPU 91 switches the four-way valve 22 so that the port a and the port d are in communication with each other and the port b and the port c are in communication with each other. Accordingly, a heating cycle in which the outdoor heat exchanger 23 functions as an evaporator and the indoor heat exchanger 31 functions as a condenser is provided.

The refrigerant discharged from the compressor 21 flows through the discharge pipe 61 and flows in the four-way valve 22. Then, the refrigerant flows through the outdoor unit gas pipe 64 from the four-way valve 22 and flows in the gas pipe 5 via the stop valve 26. The refrigerant that has flowed through the gas pipe 5 flows in the indoor unit 3 via the gas pipe connection portion 34.

The refrigerant that has flowed in the indoor unit 3 flows through the indoor unit gas pipe 68, flows in the indoor heat exchanger 31, and exchanges heat with the indoor air taken in the indoor unit 3 and is condensed by rotation of the indoor fan 32. In this manner, the indoor heat exchanger 31 functions as a condenser, and the indoor air heated by heat exchange with the refrigerant in the indoor heat exchanger 31 is blown into the room through the air outlet (not shown). As a result, the room where the indoor unit 3 is installed is heated.

The refrigerant that has flowed out from the indoor heat exchanger 31 flows through the indoor unit liquid pipe 67 and flows in the liquid pipe 4 via the liquid pipe connection portion 33. The refrigerant that has flowed through the liquid pipe 4 and flowed in the outdoor unit 2 via the stop valve 25 flows through the outdoor unit liquid pipe 63 and is reduced in pressure when passing through the expansion valve 24. The degree of opening of the expansion valve 24 during the heating operation is adjusted so that the discharge temperature of the compressor 21 becomes a predetermined target temperature. The refrigerant that passed through the expansion valve 24 flows through the outdoor unit liquid pipe 63 and flows in the outdoor heat exchanger 23.

The refrigerant that has flowed in the outdoor heat exchanger 23 exchanges heat with the outside air taken in the outdoor unit 2 and is evaporated by rotation of the outdoor fan 27. The refrigerant that has flowed to the refrigerant pipe 62 from the outdoor heat exchanger 23 flows through the four-way valve 22, the refrigerant pipe 69, the accumulator 28, and the suction pipe 66. Then, the refrigerant is sucked and re-compressed by the compressor 21.

If the outside air temperature is low while the air conditioner 1 is performing the heating operation, frost is generated in the outdoor heat exchanger 23 that functions as an evaporator. If a large amount of frost is generated in the outdoor heat exchanger 23, it prevents heat exchange between the refrigerant and the outside air by the outdoor heat exchanger, which deteriorates the heat exchange capability in the outdoor heat exchanger 23. In view of this, in the case where the air conditioner 1 according to the present embodiment satisfies a defrosting start condition to be described later, the following reverse defrosting operation is performed.

### 3. Reverse Defrosting Operation

In the case where the outdoor unit 2 performs the reverse defrosting operation, the CPU 91 switches the four-way valve 22 to a state shown by the broken line as shown in FIG. 1, i.e., so that the port a and the port b of the four-way valve 22 are in communication with each other and the port c and the port d are in communication with each other. Accordingly, in the refrigerant circuit 10, the outdoor heat exchanger 23 functions as a condenser and the indoor heat exchanger 31 functions as an evaporator. At this time, the expansion valve 24 is made fully open and the operations of the outdoor fan 27 and the indoor fan 32 are stopped.

In the reverse defrosting operation, a high-temperature refrigerant discharged from the compressor 1 is made to flow in the outdoor heat exchanger, and frost that has adhered to the outdoor heat exchanger 23 is melted. In the reverse defrosting operation, by stopping the rotation of the outdoor fan 27, the heat exchange between the refrigerant and the frost is performed prior to the heat exchange between the refrigerant and the outside air. The refrigerant condensed by heat exchange with the frost that has adhered to the outdoor heat exchanger 23 flows in the indoor heat exchanger 31 through the expansion valve 24, is evaporated by heat exchange with the indoor air, and is sucked by the compressor 21.

The reverse defrosting operation is terminated when a constant time (e.g., 10 minutes) has elapsed or when the temperature of the outdoor heat exchanger 23 becomes a predetermined temperature (e.g., 10° C. or more) after the reverse defrosting operation is started, and the above-mentioned heating operation is restarted.

Here, during the operation of the outdoor fan 27, operational noise such as wind noise is typically generated. For example, as shown in FIG. 3, with the air conditioner in which the outdoor unit 2 as the heat source side unit is placed outside the room and the indoor unit 3 as the use side unit is placed inside the room, sandwiching a building wall W that partitions an indoor space and an outdoor space, a user located in the room rarely notices a change in operational noise due to stop of the rotation of the outdoor fan 27 during the reverse defrosting. However, in the case where the outdoor environment is more silent than that in the daytime for example during a midnight operation, the user located in the room notices a change in operational noise of the outdoor fan 27 when the reverse defrosting is switched.

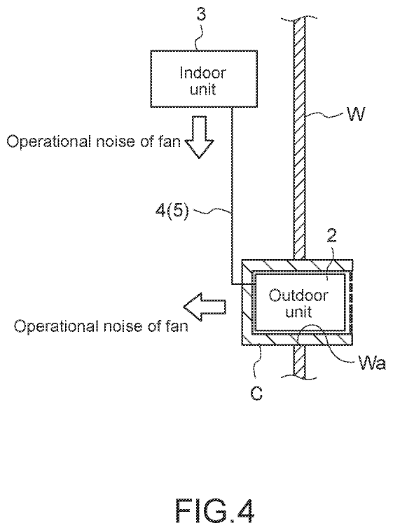

On the other hand, for example, as shown in FIG. 4, with the air conditioner in which the outdoor unit 2 as the heat source side unit is disposed in an external casing C fitted in an opening Wa penetrating the building wall W that partitions the indoor space and the outdoor space, operational noise of the outdoor fan 27 may more easily reach the user located in the room than operational noise of the indoor fan 32.

When the rotation of the outdoor fan is temporarily stopped in order to perform the reverse defrosting operation as described above, depending on an operational environment of the air conditioner or a structure of the air conditioner, some users feel discomfort from a rapid change in operational noise of the outdoor fan. For those users, the usability of the air conditioner is impaired due to the discomfort. In order to solve such a problem, the control device 90 according to the present embodiment is configured to perform the following processing during the reverse defrosting operation.

### Reverse Defrosting Operation Control

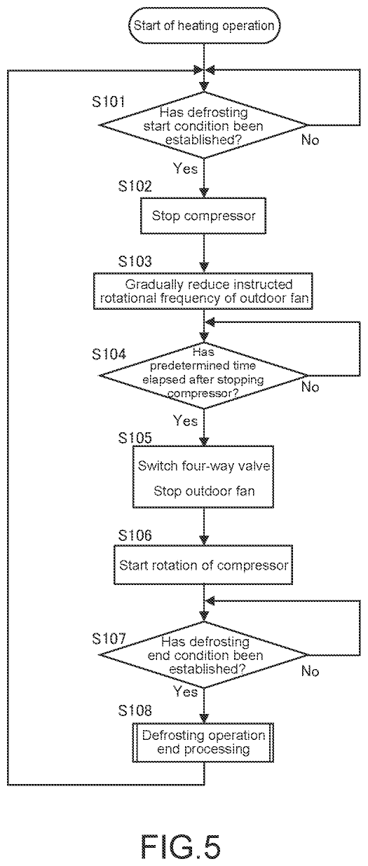

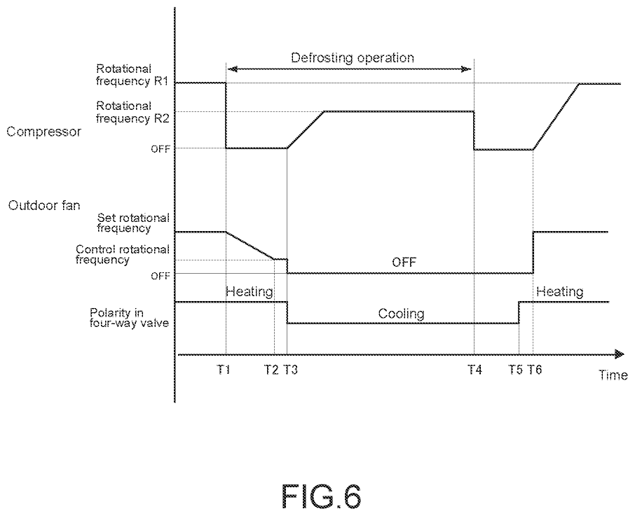

FIG. 5 is a flowchart showing an exemplary processing procedure of the reverse defrosting operation performed in the CPU 91 of the control device 90. FIG. 6 is a timing chart showing exemplary state changes of the compressor 21, the four-way valve 22, and the outdoor fan 27 during the reverse defrosting operation. Hereinafter, details of the control device 90 will be described also with reference to FIGS. 5 and 6.

When the heating operation is started, the control device 90 determines whether or not the defrosting start condition has been established in a predetermined cycle (Step 101 in FIG. 5). The defrosting start condition is not particularly limited. The defrosting start condition can be, for example, that the outside air temperature is a predetermined temperature (e.g., 10° C.) or less and a difference between the outside air temperature and the temperature of the outdoor heat exchanger 23 is a predetermined value (e.g., 15 deg) or more or that a predetermined time (e.g., 30 minutes) has elapsed from the start of the heating operation (including restart of the heating operation after the end of the reverse defrosting operation).

The control device 90 continues the heating operation in the case where the defrosting start condition has not been established (No in Step 101). In the case where the defrosting start condition has been established (Yes in Step 101), the control device 90 starts processing of stopping the operation of the compressor 21 (Step 102 in FIG. 5) and stopping the outdoor fan 27 while gradually reducing the instructed rotational frequency of the outdoor fan 27 in order to start the reverse defrosting operation (Step 103 in FIG. 5, Times T1 to T2 in FIG. 6).

The instructed rotational frequency of the outdoor fan 27 is set by the control device 90. The instructed rotational frequency is set to be any rotational frequency in a range of from 0 rpm to 1450 rpm, for example. The instructed rotational frequency is adjusted depending on required heating capability on the basis of the rotational frequency of the compressor 21, the detection temperature of the outdoor heat exchange temperature sensor 75, the detection temperature of the outside air temperature sensor 76, and the like during the heating operation.

In the present embodiment, as described above, at the time of the start of the reverse defrosting operation, the instructed rotational frequency of the outdoor fan 27 is gradually reduced from the rotational frequency (set rotational frequency in FIG. 6) immediately before the start of the reverse defrosting operation (Step 103 in FIG. 5). The term “gradually reducing” means continuously reducing or stepwisely reducing the instructed rotational frequency. Accordingly, a rapid change in operational noise of the outdoor fan 27 is suppressed as compared to the case where the instructed rotational frequency is rapidly made zero from the rotational frequency immediately before the start of the reverse defrosting operation. Thus, it is possible to prevent deterioration of the usability to the user located in the room due to a change in operational noise of the outdoor fan 27. In the following description, the processing of gradually reducing the instructed rotational frequency will be also referred to as an instructed rotational frequency reduction control.

The rate of reducing the instructed rotational frequency in the instructed rotational frequency reduction control is not particularly limited as long as the user located in the room hardly notices a change in operational noise of the outdoor fan 27. For example, any mode confirmed in advance by experiments and the like can be applied.

Moreover, in order to prevent the reverse defrosting operation from being unnecessarily prolonged, it is favorable to perform the instructed rotational frequency reduction control in a predetermined period (period of from Time T1 to Time T3 in FIG. 6) of from a time of stopping the compressor 21 to a time of performing the processing of switching the polarity in the four-way valve 22 so that the flow direction of the refrigerant discharged from the compressor 21 changes from the side of the indoor heat exchanger 31 into the side of the outdoor heat exchanger 23. From such a perspective, the rate of reducing the instructed rotational frequency during the instructed rotational frequency reduction control is set so that the outdoor fan 27 can be stopped within such a predetermined period.

It should be noted that the rate of reducing the instructed rotational frequency may be changed in accordance with the rotational frequency of the outdoor fan 27 immediately before the reverse defrosting start. For example, by reducing the rate of reducing the instructed rotational frequency along with an increase in rotational frequency of the outdoor fan 27 immediately before the reverse defrosting start, a change in operational noise of the outdoor fan 27 can be made more unnoticeable to the user located in the room. Also in this case, the rate of reducing the instructed rotational frequency is favorably set so that the outdoor fan 27 can be stopped within the above-mentioned predetermined period.

On the other hand, when the rotational frequency of the outdoor fan 27 immediately before the start of the defrosting is relatively small, operational noise of the outdoor fan 27 at the time of the start of the reverse defrosting operation is also relatively small. Therefore, the rate of reducing the instructed rotational frequency may be set to be relatively high.

In the present embodiment, the control device 90 sets a control rotational frequency as a desired value in advance and performs the instructed rotational frequency reduction control with respect to the outdoor fan 27 until the rotational frequency of the outdoor fan 27 reaches the control rotational frequency from the above-mentioned set rotational frequency. The control rotational frequency is set to be, for example, any rotational frequency by which the user located in the room cannot or hardly notice operational noise of the outdoor fan 27. Here, the control device 90 reduces the instructed rotational frequency to the control rotational frequency at a constant rate (e.g., 10 rotations per second).

Further, the control device 90 determines whether or not the predetermined time has elapsed after stopping the compressor 21 as shown in FIG. 5 (Step 104). The predetermined time refers to any time of from the stop of the compressor 21 to the time when the flow of the refrigerant becomes gentle in the refrigerant circuit 10. In the present embodiment, the predetermined time corresponds to the above-mentioned predetermined period (Time T1 to T3 in FIG. 6). When the predetermined time has elapsed (“Yes” in Step 104), the control device 90 stops the outdoor fan 27 and switches the polarity in the four-way valve 22 so that the flow direction of the refrigerant discharged from the compressor 21 changes from the side of the indoor heat exchanger 31 into the side of the outdoor heat exchanger 23 (Step 105, Time T3 in FIG. 6).

Stopping the outdoor fan 27 refers to setting the instructed rotational frequency to zero. As a result, the outdoor fan 27 stops after the rotation slows down for a while. Since the control rotational frequency is set to be the rotational frequency by which the user located in the room cannot or hardly notice operational noise of the outdoor fan 27 as described above, even if the outdoor fan 27 is stopped at this rotational frequency, the user located in the room does not notice a change in operational noise of the outdoor fan 27, which is associated with the stop. In order to prevent the instructed rotational frequency reduction control from being unnecessarily prolonged, the power consumption of the control device 90 can be reduced. It should be noted that the control device 90 stops the outdoor fan 27 when the above-mentioned predetermined time has elapsed also in the case where the rotational frequency of the outdoor fan 27 has not been reduced to the control rotational frequency

Subsequently, as shown in FIG. 5, the control device 90 starts the rotation of the compressor 21 and causes a high-temperature refrigerant to flow in the outdoor heat exchanger (Step 106, Time T3 in FIG. 6). Accordingly, the reverse defrosting of the outdoor heat exchanger 23 is started.

As shown in FIG. 6, the rotational frequency of the compressor 21 (rotational frequency R2 in FIG. 6) during the reverse defrosting operation is set to be the rotational frequency lower than the rotational frequency of the compressor 21 (rotational frequency R1 in FIG. 6) during the heating operation. The rotational frequency R2 may be rotational frequency by which the amount of heat sufficient for melting frost that has adhered to the outdoor heat exchanger 23 within a limited defrosting time (e.g., at most 15 minutes) can be provided. Depending on a condition, the rotational frequency R2 may be the same rotational frequency as the rotational frequency R1 or may be a rotational frequency larger than the rotational frequency R1.

Subsequently, as shown in FIG. 5, the control device 90 determines whether or not a defrosting end condition has been established (Step 107). The defrosting end condition can be, for example, the time when the predetermined time (e.g., 10 minutes) has elapsed from the start of the reverse defrosting operation or the time when the temperature of the outdoor heat exchanger 23 (the detection temperature of the outdoor heat exchange temperature sensor 75) becomes equal to or higher than the predetermined temperature (e.g., 10° C.). In the case where the defrosting end condition has not been established (No in Step 107), the control device 90 continues the reverse defrosting operation. In the case where the defrosting end condition has been established (Yes in Step 107), the control device 90 performs defrosting operation end processing (Step 108, Time T4 to T7 in FIG. 6).

As shown in FIG. 6, the defrosting operation end processing includes processing of stopping the compressor 21 (Time T4), processing of switching the four-way valve 22 so that the flow direction of the refrigerant discharged from the compressor 21 changes from the side of the outdoor heat exchanger 23 into the side of the indoor heat exchanger 31 (Time T5), and processing of rotating the compressor 21 and the outdoor fan 27 (T6). The compressor 21 and the rotational frequency of the outdoor fan 27 are each set to be a rotational frequency by which heating performance required at the time of restarting the heating operation is obtained.

Since in the air conditioner 1 according to the present embodiment, the rotational frequency of the outdoor fan 27 is gradually reduced at the time of the start of the reverse defrosting operation as described above, the user located in the room hardly notices a change in operational noise associated with the stop of the outdoor fan 27 as compared to the case where the rotational frequency of the outdoor fan 27 is suddenly set to zero.

Accordingly, for example, also during an operation in the midnight time zone in which the outdoor environment is relatively silent or in the air conditioner (see FIG. 4) in which the outdoor unit 2 as the heat source side unit is disposed in the external casing C fitted in the opening Wa penetrating the building wall W that partitions the indoor space and the outdoor space, it is possible to prevent deterioration of comfort and usability for the user located in the room by reducing discomfort felt by the user located in the room due to a sudden change in operational noise of the outdoor fan 27.

It should be noted that at the start of the operation of the outdoor fan 27 in the defrosting operation end processing, the control device 90 is not limited to the case where the instructed rotational frequency of the outdoor fan 27 is rapidly increased from zero to the set rotational frequency (see FIG. 6), and the instructed rotational frequency may be gradually increased to the set rotational frequency from zero. Accordingly, also at the time of restarting the heating operation, a change in operational noise of the outdoor fan 27 can be made unnoticeable to the user located in the room. Thus, deterioration of comfort and usability can be prevented.

### REFERENCE SIGNS LIST

1 air conditioner
2 outdoor unit
3 indoor unit
10 refrigerant circuit
21 compressor
22 four-way valve
23 indoor heat exchanger
24 expansion valve
27 outdoor fan
31 indoor heat exchanger
90 control device

1. An air conditioner, comprising:
a refrigerant circuit including a compressor, an outdoor heat exchanger, an indoor heat exchanger, a pressure reducer that is disposed between the outdoor heat exchanger and the indoor heat exchanger, and a flow channel switching unit that switches a flow direction of a refrigerant discharged from the compressor;
an outdoor fan that blows the air to the outdoor heat exchanger; and
a control device that sets an instructed rotational frequency which is a rotational frequency for driving the outdoor fan, wherein
the control device performs processing of stopping the outdoor fan while gradually reducing the instructed rotational frequency in a case where it is determined that a predetermined defrosting start condition is satisfied during a heating operation.

2. The air conditioner according to claim 1, further comprising
an external casing fitted in an opening of a building wall that partitions an indoor space and an outdoor space, wherein
the outdoor heat exchanger and the outdoor fan are disposed in the external casing.

3. The air conditioner according to claim 1, wherein
the control device performs processing of stopping the outdoor fan in a predetermined period of from a time of stopping the compressor to a time of performing processing of switching a flow direction of the refrigerant from the indoor heat exchanger to the outdoor heat exchanger.

4. The air conditioner according to claim 3, wherein
the processing of stopping the outdoor fan includes control to gradually reduce the instructed rotational frequency to a pre-set control rotational frequency and control to set the instructed rotational frequency to zero.

5. The air conditioner according to claim 1, wherein
the processing of stopping the outdoor fan reduces the instructed rotational frequency continuously, stepwisely, or at a constant rate.
